(19) United States
(12) Patent Application Publication
(10) Pub. No.: US 2003/0043814 A1
(43) Pub. Date: Mar. 6, 2003

(54) PCM call-processing apparatus and method for mobile communication system

(75) Inventor: Il-Ryul Lee, Gyeonggi-Do (KR)

Correspondence Address: FLESHNER & KIM, LLP, P.O. Box 221200, Chantilly, VA, 20153-1200, US

(73) Assignee: LG Electronics Inc.

(21) Appl. No.: 10/233,436

(22) Filed: Sep. 4, 2002

(30) Foreign Application Priority Data
Sep. 5, 2001 (KR) 54451/2001

(51) Int. Cl. H04L 12/28

(52) U.S. Cl. 370/395.6

(57) ABSTRACT

A PCM call processing apparatus includes an ATM processing unit for processing voice packets from an ATM switching unit of a mobile switching center, a traffic pool for processing PCM voice data, a PCM call processor interposed between the ATM processing unit and the traffic pool for performing selective transcoding operations based on data type, a network interface for connecting the traffic pool to a PSTN, and an IWU controller for controlling the ATM processing unit, the traffic pool, the PCM call processor, and the network interface. The PCM call processor includes a transcoder for transcoding a voice packet from the ATM processing unit and the voice data from the traffic pool, a realignment unit for realigning PCM voice data from the traffic pool, a reference processor for generating a synchronization signal based on a synchronization and clock signals from the ATM processing unit and the traffic pool, and a PCM call controller for controlling the transcoder and realignment unit based on a call control signal from a vocoder controller. A PCM call processing method includes receiving a transcoding request and a call control signal, determining whether the call control signal is for PCM data transmission or AMR packet transmission, configuring a PCM data transmission channel when the call control signal is a PCM data transmission control signal, realigning the received PCM data in a timeline, and transmitting the received data to an ATM processing unit.

### BACKGROUND OF THE INVENTION

1. Field of the Invention

The present invention relates to a mobile communication system, and in particular to an apparatus and method for processing calls expressed as pulse code modulation (PCM) signals transmitted between mobile switching centers (MSCs) in a mobile communication system.

2. Background of the Related Art

FIG. 1 is a block diagram illustrating a 3^{rd} generation partnership project (3GPP) system based on a core network (CN) model specified in TS23.205 V4.0.0 of a 3GPP. As depicted, the 3GPP system includes radio network controllers (RNCs) 11-1 and 11-2 for controlling a radio communication, serving MSC (SMSCs) 12-1 and 12-2 for performing asynchronous transfermode (ATM) switching associated with call processing, and gateway MSC (GMSCs) 13-1 and 13-2 for performing a gateway function for establishing connections to a public switched telephone network (PSTN), legacy network, and external network.

The SMSC 12-1(12-2) and the GMSC 13-1(13-2) each include a MSC 14 and an inter-working unit (IWU) 15 for processing PCM data. The IWU 15 connects a transmission side MSC to a reception side MSC to enable different kinds of networks to be integrated as one communication network.

In the above-described 3GPP system, voice and data signals are transmitted by a lu user plane (UP) protocol used at an lu interface between the RNC 11-1(11-2) and the MSC 14 and an Nb UP protocol used at an Nb interface between the MSC 14 and the IWU 15. Logically, the Nb UP protocolis supported between MSCs. However, voice packet transmission through the Nb interface is possible in addition to the PCM data transmission in the actual network construction.

FIG. 2 is a block diagram illustrating a construction of the IWU. As depicted, the IWU 15 includes an ATM processing unit 21 for converting ATM voice data from ATM switching fabrics (not shown) of the MSC 14 to a voice packet by processing at an ATM adaptation layer (AAL2); a vocoder 22 for transcoding the voice packet processed at the ATM processing unit 21 into PCM voice data; a traffic pool 23 for storing the PCM data transcoded by the vocoder 22; an E1/No.7 interface 24 for providing PSTN matching in order to transmit the PCM data stored in the traffic pool 23 to the PSTN; and an IWU controller 25 for coordinately controlling the ATM processing unit 21, vocoder 22, traffic pool, and E1/No.7 interface.

FIG. 3 is a block diagram illustrating the vocoder 22 in FIG. 2. This vocoder includes a transcoder 31 for transcoding the voice packet received from the ATM processing unit 21 or the PCM voice data received from the traffic pool 23; a reference processor 32 for receiving a synchronizing signal and a clock signal from the ATM processing unit 21 and the traffic pool 23 and generating a synchronizing control signal; and a vocoder controller 33 for controlling the operations of the transcoder 31 and the reference processor 32.

In the 3GPP system, a communication channel between the mobile terminal and a terminal connected to a PSTN is established in order of the RNC 11-1(11-2), the SMSC 12-1(12-2), the GMSC 13-1(13-2), and the PSTN. The IWU 15 of the GMSC 13-1(13-2) allows the mobile terminal to communicate with the terminal connected to the PSTN.

In case of the communication in an independent network, the communication path is established in order of the RNC 11-1(11-2), the SMSC 12-1(12-2), and the RNC 11-1(11-2). Here, call processing can be controlled by the IWU 15 of the SMSC 12-11(2-2).

Call processing in the lu interface between the RNC 11-1(11-2) and the SMC 14 is performed by the lu UP protocol, when the call connection is established, the vocoder 22 of the IWU 15 decodes a voice packet into PCM voice data or encodes PCM voice data into an voice packet.

An AMR voice packet is converted into PCM voice data by the transcoder 31 of the vocoder 22 and transmitted through the E1/No.7 interface 24 according to a synchronizing signal generated at the traffic pool 23.

On the other hand, PCM voice data from a terminal or an additional service apparatus associated with the traffic pool and PCM voice data from the PSTN through the E1/No.7 interface 24 are transmitted to the vocoder 22 according to the synchronizing signal and then converted into voice packets having an AMR UP frame structure by the transcoder 31. The transcoded voice packets are then transmitted to the ATM processing unit 21.

The voice packet is mapped to an ATM cell payload in the ATM processing unit 21, so as to be transmitted to the superior MSC 14. The traffic transmission by the IWU is thus completed.

In the case of call processing based on the up-frame type voice packet at the interface between the MSCs defined by 3GPP, the conventional vocoder works well because the vocoder performing transcoder free operation (TrFO). However, when PCM data based-call processing is required (i.e., when the 3GPP system inter-works with the conventional network), problems occur because the voice packet must be converted into the PCM data and the PCM data should be transmitted to other MSCs through the PSTN, resulting in complicated call processing.

In other words, when it is required that a MSC of the 3GPP system inter-works with a different system or a MSC of an existing network for call processing, the PCM call processing should be performed through the PSTN because the transcoder is placed in an IWU. This delays call connection and complicates the communication channel. Both of which produce a degradation of service quality.

### SUMMARY OF THE INVENTION

An object of the invention is to solve at least the above problems and/or disadvantages and to provide at least the advantages described hereinafter.

It is an object of the present invention to provide a PCM (pulse code modulation) call processing apparatus of an IWU, which performs PCM call processing between MSCs.

It is another object of the present invention to provide a PCM call processing apparatus which minimizes call setup delay and call setup paths by performing PCM call processing at a vocoder of an IWU between MSCs without intervention of PSTN.

To achieve these and other objects, the PCM call processing apparatus of the present invention comprises an ATM processing unit for processing voice packets from an ATM switching unit of a MSC, a traffic pool for processing PCM voice data, a PCM call processor interposed between the ATM processing unit and the traffic pool for selectively transcoding according to kinds of data, a network interface for connecting the traffic pool to a PSTN, and an IWU controller for controlling the ATM processing unit, the traffic pool, the PCM call processor, and the network interface.

The PCM call processor includes a transcoder for transcoding a voice packet from the ATM processing unit and the voice data from the traffic pool, a realignment unit for realigning PCM voice data from the traffic pool, a reference processor for generating a synchronization signal based on a synchronization and clock signals from the ATM processing unit and the traffic pool, and a PCM call controller for controlling the transcoder and realignment unit on the basis of the call control signal from a vocoder controller.

To achieve the above objects, the PCM call processing method of the present invention comprises the steps of receiving a transcoding request and a call control signal, determining whether the call control signal is for PCM data transmission or AMR packet transmission, configuring a PCM data transmission channel when the call control signal is a PCM data transmission control signal, realign the received PCM data in timeline, and transmitting the received data to an ATM processing unit. The PCM call processing method further comprises the steps of configuring an AMR packet transmission channel when the call control signal is an AMR packet transmission control signal, transcoding the received PCM data into an AMR packet, and transmitting the AMR packet to an ATM processing unit

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a core network of a 3GPP system;

FIG. 2 is a block diagram illustrating an IWU of the core network in FIG. 1;

FIG. 3 is a block diagram illustrating a vocoder of the IWU in FIG. 2;

FIG. 4 is a block diagram illustrating a PCM call processing apparatus of an IWU in accordance with a preferred embodiment of the present invention; and

FIG. 5 is a flow chart illustrating a PCM call processing method in accordance with the preferred embodiment of the present invention.

### DETAILED DESCRIPTION OF PREFERRED EMBODIMENTS

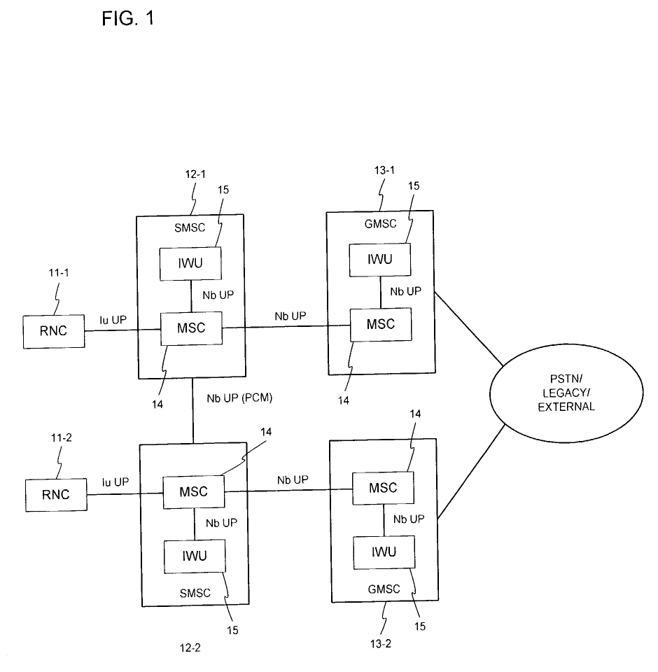

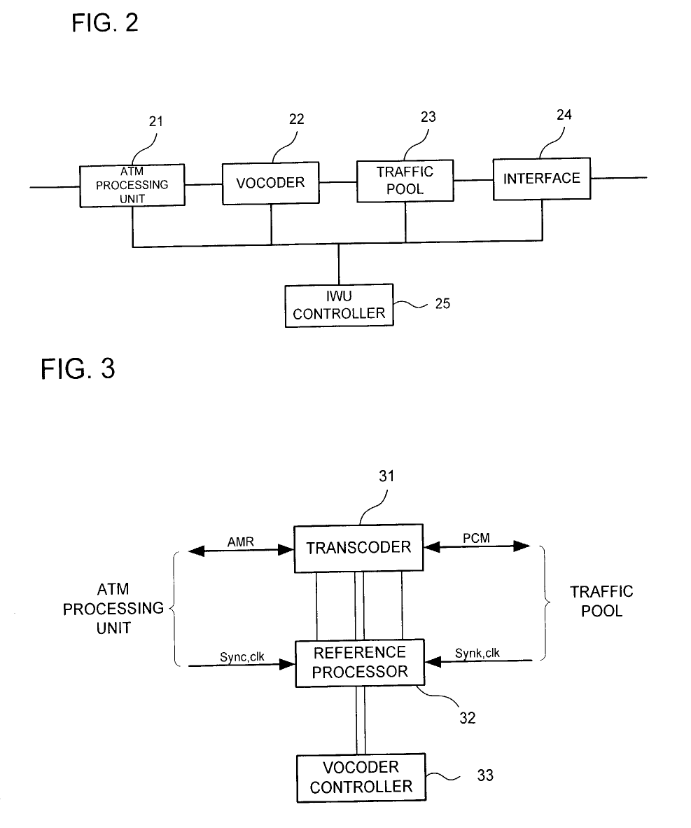

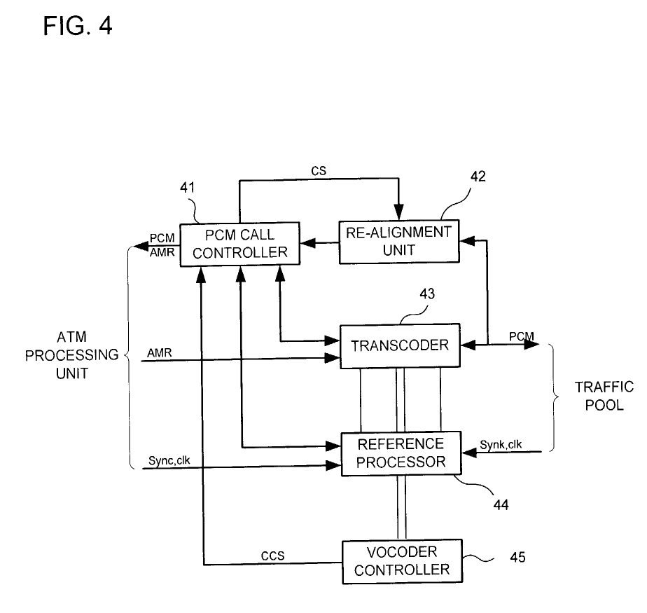

A preferred embodiment of the present invention will now be described with reference to accompanying drawings. Since the present invention may be substituted for the conventional vocoder of FIG. 2, the PCM call processing apparatus of the present invention will be described with reference to FIG. 1, FIG. 2, and FIG. 4.

FIG. 4 is a block diagram illustrating a PCM call processing apparatus of an IWU in accordance with a preferred embodiment of the present invention. As depicted, the PCM call processing unit includes a PCM call controller 41, a realignment unit 42, a transcoder 43, a reference processor 44, and a vocoder controller 45.

The vocoder controller 45 receives a transcoding request signal for a certain channel from the IWU controller 25 together with a call control signal indicating the certain channel is a PCM channel, and transmits the transcoding request signal and the call control signal to the PCM call controller 41.

Regarding a channel requested for the PCM call, the PCM call controller 41 transmits data received from the traffic pool 23 to the ATM processing unit 21 via the transcoder 43 or realignment unit 42 according to a synchronization signal from the reference processor 44.

The realignment unit 42 realigns, in timeline, data identical with the PCM voice data that the transcoder 43 receives from the traffic pool 23 in time and then stores the realigned data in a memory (not shown). That is, the realignment unit 42 stores the PCM data during a PCM cycle (for example, 125 μs) and then stores the same amount of next PCM data during the next PCM cycle. Also, the realignment unit 42 transmits the stored PCM data to the PCM call controller 41 on the first-in-first-out base according to a synchronization signal from the ATM processing unit 21.

The transcoder 43 transcodes the voice packet received from the ATM processing unit 21 and the PCM voice data received from the traffic pool 23.

The reference processor 44 generates a synchronization control signal based on synchronization and clock signals for an AMR voice packet and PCM voice data respectively received from the ATM processing unit 21 and the traffic pool 23, and delivers the synchronization control signal to each part of the vocoder 22.

Operation of the PCM call processing apparatus of the IWU in accordance with a preferred embodiment of the present invention will now be described.

In processing a call between the MSCs of a 3GPP system, in case of a TrFO, an voice packet having an AMR UP frame format received from a RNC through a lu interface can be processed by a Nb UP protocol. Further, the 3GPP system should be designed so as to be able to interface with conventional communication networks that are based on the PCM data communication. In case that the MSC of the 3GPP system includes the IWU having a transcoder function, the vocoder of the IWU should be able to perform a PCM call processing.

In FIG. 4, a vocoder 22 of the present invention is designed so as to bypass the PCM data by expanding its dedicated transcoding function. First, when a call control signal generated in the MSC during a call processing is transmitted to a vocoder controller 45 of the vocoder 22 via the IWU controller 25, the vocoder controller 45 extracts specific channel request information and control information on either a general call or a PCM call by analyzing the call control signal. When the call control information is PCM call control information, the vocoder controller 45 transmits the PCM voice data transcoding request and the AMR voice packet transcoding request to the transcoder 43 together with a channel transcoding request for corresponding channel based on the CPM call control information through the reference processor 44.

Also, the vocoder controller 45 requests a two-way transcoding to the transcoder 43 and sends PCM call controller 41 a control signal (ccs) required for processing the PCM voice data received from the realignment unit 42 or the AMR voice packet received from the transcoder 43 for respective calls and channels.

The reference processor 44 generates synchronization control signals for every part based on the AMR packet synchronization signal received from the ATM processing unit 21 and the PCM voice data transmission synchronization signal received from the traffic pool 23, and sends the synchronization signals to corresponding parts.

The transcoder 43 performs transcoding of the pertinent channel according to the control information from the vocoder controller 45 through the reference processor 44, and then transmits the transcoded AMR voice packet and PCM voice data to the respective PCM call controller 41 and traffic pool 23 according to the synchronization control signal from the reference processor 44.

Regarding the PCM call channel, the PCM call controller 41 transmits the data received from the realignment unit 42 to the ATM processing unit 21 according to the control signal received from the reference processor 44 under control of the vocoder controller 45. And, the realignment unit 42 receives the data, which is identical with the PCM voice data to be transcoded in the transcoder 43, from the traffic pool 23 and stores the same in a dual port memory (not shown) for realigning in timeline.

Also, the realignment unit 42 sequentially stores the data as one PCM frame (vocoder processing capacity) in the memory, and simultaneously reads previously stored data per frame according to the synchronization control signal from the reference processor 44 so as to send the read data to the PCM call controller 41.

The PCM call controller 41 performs channel selection according to the control signal (ccs) received from the vocoder controller 45, such that the data structure of the respective voice data channel is identical with that intended by the vocoder controller 45.

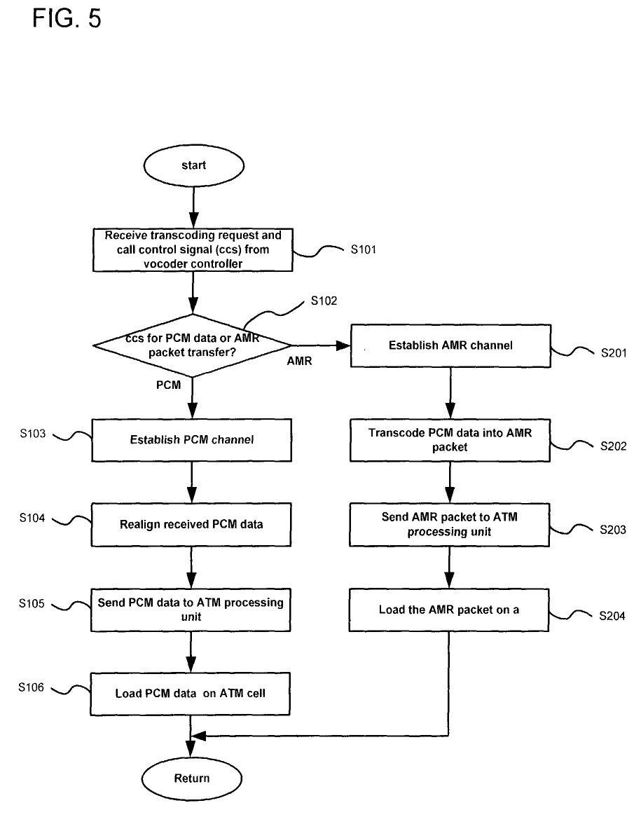

A PCM call processing method according to a preferred embodiment of the present invention will be described with reference to FIG. 5 hereinafter. FIG. 5 is a flowchart illustrating the PCM call processing method of the present invention. As depicted, when a call control signal is received from the IWU controller 25, the vocoder controller 45 analyzes the call control signal. If the call control signal is a PCM call control signal, the vocoder controller 45 requests two-way transcoding to the transcoder 43 and transmits a control signal (ccs) indicating a channel request and a call type to the PCM call controller 41, at step S101.

The PCM call controller 41 determines whether the call is for PCM voice data processing or AMR packet processing at step S102. If it is determined that the call is a PCM voice data processing call, the PCM call controller 41 sets a PCM data transmission channel according to the control signal (ccs) and transmits a control signal (cs) to the realignment unit 42 at step S103. The realignment unit 42 realigns the PCM voice data received from the traffic pool 23 and temporarily stores the realigned data at step S104. Afterward, the PCM call controller 41 transmits the realigned PCM voice data to the ATM processing unit 21 according to the synchronization signal received from the reference processor 44 at step S105. The ATM processing unit 21 transmits the PCM voice data to the superior MSC system through a pertinent channel using an ATM cell at step S106.

At step S102, when the call is an AMR packet processing call, the PCM call controller 41 sets an AMR packet transmission channel according to a control signal (CCS), at step S201. The transcoder 42 thereby transcodes the PCM voice data received from the traffic pool 23 into the AMR packet at step S202. The transcoded AMR packet is then transmitted to the ATM processing unit 21 by the PCM call controller 41 according to the synchronization signal from the reference processor 44, at step S203. The ATM processing unit 21 loads the AMR packet on an ATM cell and transmits the ATM cell to the superior MSC system through a pertinent channel, at step S204.

As described above, in the PCM call processing apparatus of the present invention, the PCM call processing between MSCs is performed at the vocoder of IWU such that it is possible to reduce the call setup time and intermediate channels caused by intervention of PSTN, resulting in enhanced service quality.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A PCM call processing apparatus, comprising:
an ATM processing unit for processing voice packets from an ATM switching unit of an MSC;
a traffic pool for processing PCM voice data;
a PCM call processor, interposed between the ATM processing unit and the traffic pool, for selectively transcoding based on data type;
a network interface for connecting the traffic pool to a PSTN; and
an IWU controller for controlling the ATM processing unit, the traffic pool, the PCM call processor, and the network interface.

2. The PCM call processing apparatus of claim 1, wherein the PCM call processor transcodes a voice packet from the ATM processing unit into PCM voice data.

3. The PCM call processing apparatus of claim 1, wherein the PCM call processor transcodes PCM voice data from the traffic pool into a voice packet or by-passes the PCM voice data according to a control signal from the IWU controller.

4. The PCM call processing apparatus of claim 1, wherein the PCM call processor includes:
a transcoder for transcoding a voice packet from the ATM processing unit and the voice data from the traffic pool;
a realignment unit for realigning PCM voice data from the traffic pool;
a reference processor for generating a synchronization signal based on a synchronization and clock signals from the ATM processing unit and the traffic pool; and
a PCM call controller for controlling the transcoder and realignment unit based on a call control signal from a vocoder controller.

5. The PCM call processing apparatus of claim 4, wherein the PCM call controller receives data from one of the transcoder and the realignment unit according to the call control signal, and transmits the received data to the ATM processing unit.

6. The PCM call processing apparatus of claim 4, wherein the realignment unit stores PCM voice data in a memory at a PCM voice data rate, sequentially reads the stored PCM data according to the synchronization signal from the ATM processing unit, and transmits the read data to the PCM call controller.

7. The PCM call processing apparatus of claim 5, wherein the realignment unit stores PCM voice data from the traffic pool in a memory at a PCM voice data rate, sequentially reads the stored PCM data according to the synchronization signal from the ATM processing unit, and transmits the read data to the PCM call controller.

8. A PCM call processing apparatus, comprising:
an ATM processing unit for processing a voice packet from an ATM switching unit of a MSC;
a traffic pool for processing PCM voice data;
a PCM call processor, interposed between the ATM processing unit and the traffic pool, for selectively transcoding according to kinds of data;
a network interface for connecting the traffic pool to a PSTN; and
an IWU controller for controlling the ATM processing unit, the traffic pool, the PCM call processor, and the network interface,
wherein the PCM call processor transcodes PCM voice data from the traffic pool into a voice packet or by-passes the PCM voice data according to a control signal from the IWU controller.

9. The PCM call processing apparatus of claim 8, wherein the PCM call processor transcodes a voice packet from the ATM processing unit into PCM voice data.

10. The PCM call processing apparatus of claim 8, wherein the PCM call processor includes:
a transcoder for transcoding a voice packet from the ATM processing unit and the voice data from the traffic pool;
a realignment unit for realigning PCM voice data from the traffic pool;
a reference processor for generating a synchronization signal based on a synchronization and clock signals from the ATM processing unit and the traffic pool; and
a PCM call controller for controlling the transcoder and realignment unit based on a call control signal from a vocoder controller.

11. The PCM call processing apparatus of claim 10, wherein the PCM call controller receives data from one of the transcoder and the realignment unit according to the call control signal and transmits the received data to the ATM processing unit.

12. The PCM call processing apparatus of claim 10, wherein the realignment unit stores PCM voice data in a memory at a PCM voice data rate, sequentially reads the stored PCM data according to the synchronization signal from the ATM processing unit, and transmits the read data to the PCM call controller.

13. The PCM call processing apparatus of claim 11, wherein the realignment unit stores PCM voice data from the traffic pool in a memory at a PCM voice data rate, sequentially reads the stored PCM data according to the synchronization signal from the ATM processing unit, and transmits the read data to the PCM call controller.

14. A PCM call processing apparatus, comprising:
an ATM processing unit for processing voice packets from an ATM switching unit of an MSC;
a traffic pool for processing PCM voice data;
a PCM call processor, interposed between the ATM processing unit and the traffic pool, for selectively transcoding based on data type;
a network interface for connecting the traffic pool to a PSTN; and
an IWU controller for controlling the ATM processing unit, the traffic pool, the PCM call processor, and the network interface,
wherein the PCM call processor includes:
a transcoder for transcoding a voice packet from the ATM processing unit and the voice data from the traffic pool;
a realignment unit for realigning PCM voice data from the traffic pool; a reference processor for generating a synchronization signal based on a synchronization and clock signals from the ATM processing unit and the traffic pool; and
a PCM call controller for controlling the transcoder and realignment unit based on a call control signal from a vocoder controller.

15. The PCM call processing apparatus of claim 14, wherein the PCM call controller receives data from one of the transcoder and the realignment unit according to the call control signal and transmits the received data to the ATM processing unit.

16. The PCM call processing apparatus of claim 14, wherein the realignment unit stores PCM voice data in a memory at a PCM voice data rate, sequentially reads the stored PCM data according to the synchronization signal from the ATM processing unit, and transmits the read data to the PCM call controller.

17. The PCM call processing apparatus of claim 15, wherein the realignment unit stores PCM voice data from the traffic pool in a memory at a PCM voice data rate, sequentially reads the stored PCM data according to the synchronization signal from the ATM processing unit, and transmits the read data to the PCM call controller.

18. A PCM call processing method, comprising:
receiving a transcoding request and a call control signal;
determining whether the call control signal is for PCM data transmission or AMR packet transmission;
configuring a PCM data transmission channel when the call control signal is a PCM data transmission control signal;
realigning the received PCM data in a timeline; and
transmitting the received data to an ATM processing unit.

19. The PCM call processing method of claim 18, further comprising:
configuring an AMR packet transmission channel when the call control signal is an AMR packet transmission control signal;
transcoding the received PCM data into an AMR packet; and
transmitting the AMR packet to an ATM processing unit.

20. A PCM call processing method, comprising:
configuring an AMR packet transmission channel when a call control signal is an AMR packet transmission control signal;
transcoding the received PCM data into an AMR packet;
transmitting the AMR packet to an ATM processing unit;
configuring an AMR packet transmission channel when the call control signal is an AMR packet transmission control signal;
transcoding the received PCM data into an AMR packet; and
transmitting the AMR packet to an ATM processing unit.
